(19) United States
(12) Patent Application Publication
(10) Pub. No.: US 2011/0308692 A1
(43) Pub. Date: Dec. 22, 2011

(54) METHOD FOR THE PRODUCTION OF A SEAL

(75) Inventors: Armin Hintenlang, Birkenau (DE); Thorsten Wieland, Heidelberg (DE); Hubertus Prinzler, Rimbach (DE)

(73) Assignee: CARL FREUDENBERG KG, Weinheim (DE)

(21) Appl. No.: 13/162,594

(22) Filed: Jun. 17, 2011

(30) Foreign Application Priority Data
Jun. 17, 2010 (EP) 10006287.6

(51) Int. Cl. B32B 37/18; B32B 37/12

(52) U.S. Cl. 156/60

(57) ABSTRACT

A method for the production of a seal includes producing a support part, providing a complete coating over the support part, producing a sealing element separate from the production of the support part and adhesively bonding the support part and the sealing element so as to form a unit. The unit is inserted into an opening of a housing.

### CROSS REFERENCE TO RELATED APPLICATIONS

This application claims priority to European Patent Application No. EP 10 006 287.6, filed Jun. 17, 2010, which is hereby incorporated by reference herein in its entirety.

### FIELD

The invention relates to the production of a seal which may be employed as a radial shaft seal and includes a support part with a sealing element arranged on it.

### BACKGROUND

The production of a seal can be relatively laborious since in most seals, the sealing element is joined to the support part by means of vulcanization. Prior to the vulcanization procedure, the support part is pretreated with a binder in order to ensure proper adhesion of the sealing element. The production process is not exactly made simpler when an adhesive bond is employed to join the sealing element to the support part. Even though an adhesive bond has the advantage that the sealing element can be produced inexpensively and quickly as a separate component, it still remains necessary to clean the surface of the support parts, at least at the place where the adhesive bond is created, so as to ensure a proper bond of the sealing element to the support part.

German patent application DE 10 2006 059 397 A1 describes a seal in which the support part, which is referred to there as a support element, is configured so as to be L-shaped and its radial leg is joined to a sealing element made of PTFE (polytetrafluoroethylene) by means of an adhesive. The sealing element has a dynamic sealing lip with which it lies against the rotating shaft. In order to create a static seal, the axial leg of the support element is provided with a gasket that is inserted into a groove formed on the leg. Consequently, this seal also calls for a laborious production process.

### SUMMARY

An aspect of the present invention is to create a production method for a seal whose execution is simple and which can be realized employing simple means. In this context, the seal produced according to the method should be easy to handle and to mount in place.

In an embodiment, the present invention provides a method for the production of a seal that includes producing a support part, providing a complete coating over the support part, producing a sealing element separate from the production of the support part and adhesively bonding the support part and the sealing element so as to form a unit. The unit is inserted into an opening of a housing.

### BRIEF DESCRIPTION OF THE DRAWING

Exemplary embodiments of the present invention are described in more detail below with reference to the drawings, in which:

FIG. 1 shows a schematic depiction of a section through a seal;

FIG. 2 shows a section through a seal in which the sealing element is arranged on the side of the seal facing the medium;

FIG. 3 shows a seal having a sealing element made of an elastomer; and

FIG. 4 shows a seal having a sealing element made of PTFE that is glued onto the front face of a support part.

### DETAILED DESCRIPTION

In the method according to an embodiment of the invention, the support part is produced separately and it is provided with a coating over its entire circumference. By means of an adhesive bond, the support part thus produced is directly joined together with a sealing element, which is likewise produced separately, thus forming a unit. This unit consisting of the support part and the sealing element is then inserted into an opening in a housing. The support part itself is made of a metal or a plastic. This coating on the support part has a thickness of at least 20 μm. This coating can be produced by means of dip coating, especially with a polyamide. However, it is also possible for the coating to be made of an elastomer. Since the coating is left on the support part, the seal also acquires a slight damping function that can also contribute to the insulation of noise. There is no need for a separate part to create the static sealing since the coating present on the radial outer surface of the axial leg of the support part is employed as a static sealing means. With the coating still in place, the sealing element is glued onto the radial leg of the support part. Here, the sealing element can be arranged on one of the side surfaces of the support part or on its front face. The sealing element itself can be made of PTFE or of an elastomer.

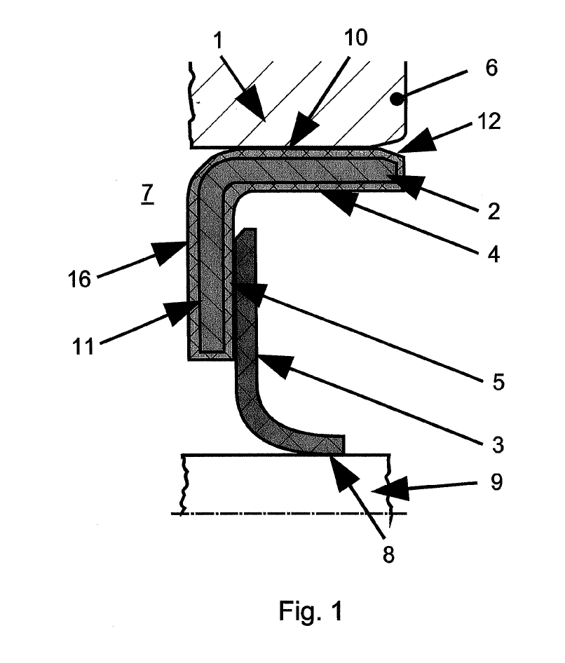

The seal 1 schematically shown in FIG. 1 consists of the support part 2 and the sealing element 3. The support part 2 is provided with the coating 4 over its entire circumference. The coating itself is made of an elastomer. The sealing element 3 is glued onto the radial leg 11 of the support part 2 by means of the adhesive bond 5. In this process, the coating 4 on the support part 2 remains in place, even in the glued area. The support part 2 and the sealing element 3 form a unit 14 that is inserted in a generally known manner into an opening 7 in a housing 6. In this process, the sealing lip 8 of the sealing element 3 comes into contact with the shaft 9 and forms the dynamic sealing lip. The coating 4 that is present on the radial outer surface of the axial leg 10 of the support part 2 is utilized to create the static seal 12 of the seal 1. Consequently, this coating constitutes the static sealing means here.

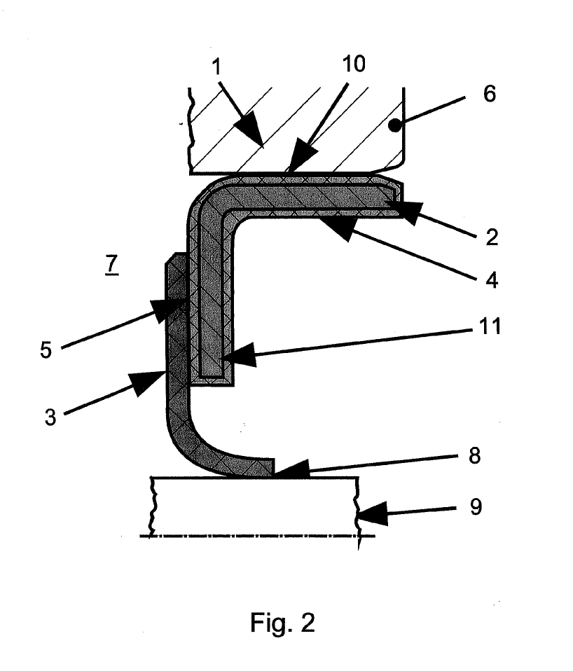

The embodiment shown in FIG. 2 corresponds to the example according to FIG. 1, but with the modification that the sealing element 3 is arranged on the side of the support part 2 that faces the inner space that is to be sealed.

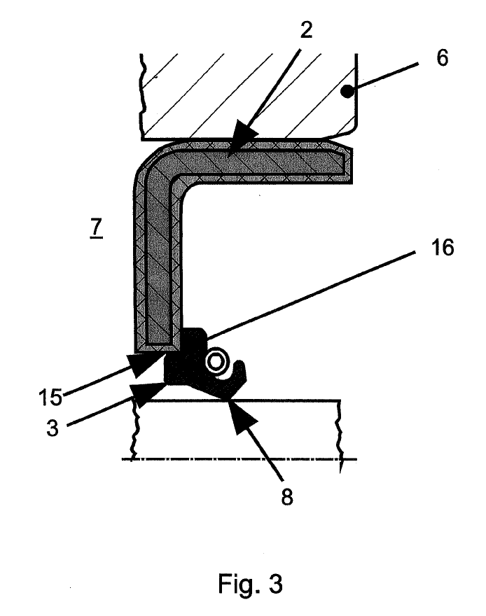

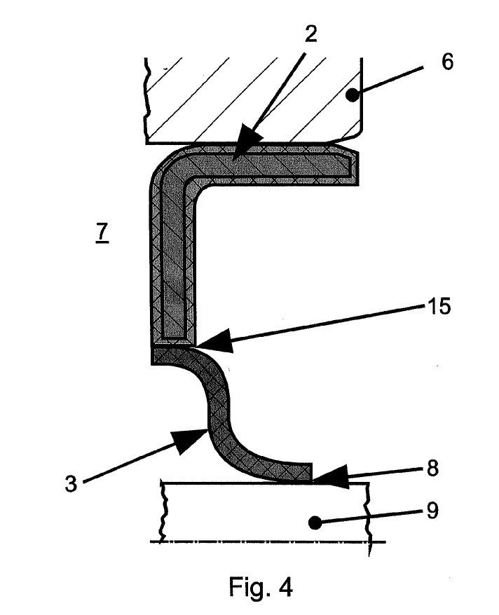

FIGS. 3 and 4 show examples in which the sealing elements 3 are glued onto the front faces 15 of the support part 2. In FIG. 4, a PTFE sealing element 3 is likewise used which assumes the shape of an S once it is inserted into the opening 7 of the housing 6. The sealing element 3 according to FIG. 3 is a sealing element 3 made of an elastomer. The sealing element 3 here is provided with an annular groove 16 that surrounds the inner edge of the support part 2, so that the adhesive surface is present on the front face 15 as well as on a side surface of the support part 2.

While the invention has been particularly shown and described with reference to preferred embodiments thereof, it will be understood by those skilled in the art that various changes in form and details may be made therein without departing from the spirit and scope of the invention.

What is claimed is:

1. A method for producing a seal comprising:
producing a support part;
providing a complete coating over the support part;
producing a sealing element separate from the production of the support part;
adhesively bonding the support part and the sealing element so as to form a unit; and
inserting the unit into an opening of a housing.

2. The method of producing a seal as recited in claim 1, wherein the support part includes a metal.

3. The method of producing a seal as recited in claim 1, wherein the support part includes a plastic.

4. The method of producing a seal as recited in claim 1, wherein the coating is a dip coating.

5. The method of producing a seal as recited in claim 4, wherein the coating includes a polyamide.

6. The method of producing a seal as recited in claim 1, wherein the coating is an elastomer.

7. The method of producing a seal as recited in claim 1, wherein the support part includes an axial leg, the method further comprising forming a static seal between a portion of the coating disposed on a radial outer surface of the axial leg of the support part and the housing.

8. The method of producing a seal as recited in claim 1, wherein the support part includes a radial leg, and wherein the adhesively bonding the support part and the seal part includes bonding the sealing element to a front face of the radial leg.

9. The method of producing a seal as recited in claim 1, wherein the support part includes a radial leg, and wherein the adhesively bonding the support part and the seal part includes bonding the sealing element to a side face of the radial leg.

10. The method of producing a seal as recited in claim 1, wherein the sealing element includes PTFE.

11. The method of producing a seal as recited in claim 1, wherein the sealing element is an elastomer.

12. The method of producing a seal as recited in claim 1, wherein the coating has a thickness of at least 20 μm.
